(19) United States
(12) Patent Application Publication
(10) Pub. No.: US 2016/0307140 A1
(43) Pub. Date: Oct. 20, 2016

(54) METHODS AND SYSTEMS FOR PROVIDING PERFORMANCE IMPROVEMENT RECOMMENDATIONS TO PROFESSIONALS

(71) Applicant: Kyruus, Inc., Boston, MA (US)

(72) Inventors: Julie Keunhee Yoo, Boston, MA (US); Graham Gardner, Sudbury, MA (US); Puneet Batra, Cambridge, MA (US); Vinay Seth Mohta, Newton, MA (US)

(21) Appl. No.: 15/195,367

(22) Filed: Jun. 28, 2016

Related U.S. Application Data
(63) Continuation of application No. 14/305,042, filed on Jun. 16, 2014.
(60) Provisional application No. 61/840,046, filed on Jun. 27, 2013.

(51) Int. Cl. G06Q 10/06; G06Q 50/22; H04L 29/08

(52) U.S. Cl. CPC G06Q 10/06393; H04L 67/306; G06Q 50/22

(57) ABSTRACT

A method for providing a performance improvement recommendation to a professional includes automatically generating, by a profile generator executing on a first computing device, a profile of a professional. The method includes automatically analyzing, by an analysis engine executing on the first computing device, the generated profile. The method includes generating, by the analysis engine, responsive to the analysis, a performance metric for the professional. The method includes comparing the generated performance metric with a second performance metric generated for a second professional. The method includes transmitting, by the analysis engine, to a second computing device associated with the professional, a recommendation for improving the performance metric based upon a result of the comparison.

### CROSS-REFERENCE TO RELATED APPLICATIONS

This application is a continuation of U.S. patent application Ser. No. 14/305,042, filed on Jun. 16, 2014, entitled “Methods and Systems for Providing Performance Improvement Recommendations to Professionals,” which claims priority from U.S. Provisional Patent Application No. 61/840,046, filed on Jun. 27, 2013, entitled “Methods and Systems for Providing Performance Improvement Recommendations to Professionals,” each of which is hereby incorporated by reference.

### BACKGROUND

The disclosure relates to providing feedback to professionals. More particularly, the methods and systems described herein relate to providing performance improvement recommendations to professionals.

A fundamental problem in conventional healthcare delivery is that there tends to be a substantial variance between physicians and their practices and procedures and results. By way of example, outcome measures for procedures like heart bypass and knee replacement differ dramatically across regions of the United States, and have been shown to correlate with procedure volume. Industry professionals attempt to improve care and control costs by standardizing processes; however, such an arbitrary approach leaves much to be desired. Similar problems plague other types of professional services providers.

### BRIEF SUMMARY

In some embodiments, the methods and systems described herein enable professionals to understand the heterogeneity in practice styles across their industries and learn from the outliers as well as from the averages. Additionally, the methods and systems described herein may provide functionality for making personalized recommendations for performance improvement based on the details of a professional's past behavior. In one aspect, a method for providing a performance improvement recommendation to a professional includes automatically generating, by a profile generator executing on a first computing device, a profile of a professional. The method includes automatically analyzing, by an analysis engine executing on the first computing device, the generated profile. The method includes generating, by the analysis engine, responsive to the analysis, a performance metric for the professional. The method includes comparing the generated performance metric with a second performance metric generated for a second professional. The method includes transmitting, by the analysis engine, to a second computing device associated with the professional, a recommendation for improving the performance metric based upon a result of the comparison.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2 is a block diagram depicting one embodiment of a system for profiling a professional;

FIG. 3A is a flow diagram depicting an embodiment of a method for profiling a professional;

FIG. 3B is a screen shot depicting one embodiment of profiles generated by a profile generator;

FIG. 3C is a screen shot depicting one embodiment of a description of a level of expertise for each of a plurality of profiled professionals;

FIG. 3D is a screen shot depicting an embodiment of a description of a level of expertise for each of a plurality of profiled professionals; and

FIG. 4 is a flow diagram depicting one embodiment of a method for providing a performance improvement recommendation to a professional.

### DETAILED DESCRIPTION

In some embodiments, the methods and systems described herein provide performance improvement recommendations to professionals and entities. Before describing methods and systems for generating and using such profiles in detail, however, a description is provided of a network in which such methods and systems may be implemented.

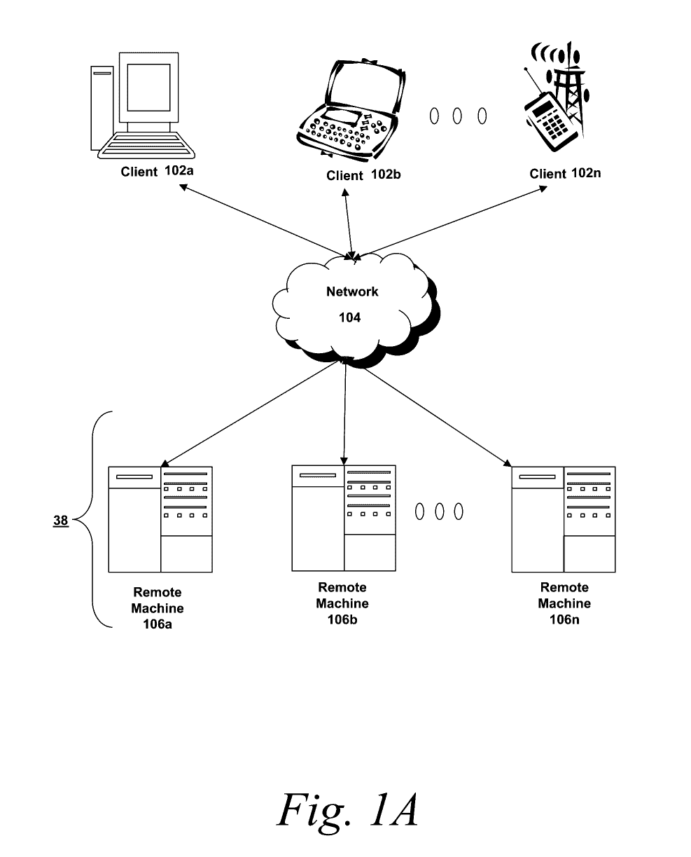

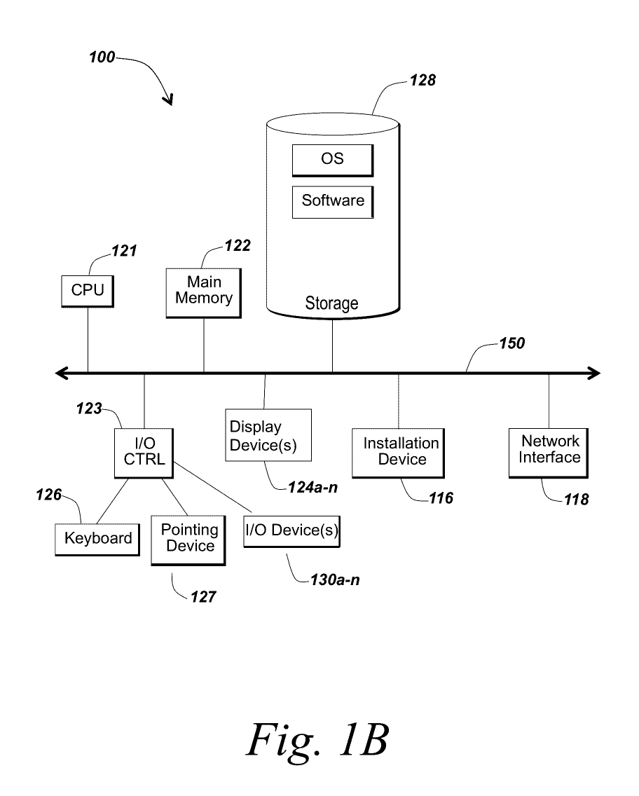

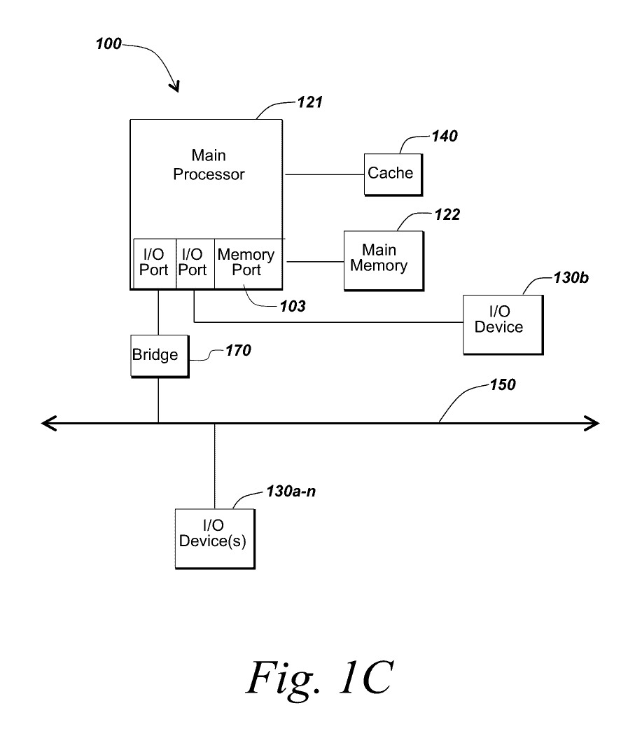

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation; desktop computer; laptop or notebook computer; server; portable computer; mobile telephone or other portable telecommunication device; media playing device; a gaming system; mobile computing device; or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash.; the Oracle iPlanet web server products provided by Oracle Corporation of Redwood Shores, Calif.; or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium device 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, CA.

Referring still to FIG. 1B, the computing device 100 may support any suitable installation device 116, such as a floppy disk drive for receiving floppy disks such as 3.5-inch disks, 5.25-inch disks or ZIP disks; a CD-ROM drive; a CD-R/RW drive; a DVD-ROM drive; tape drives of various formats; a USB device; a hard-drive; or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, each of which may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCl/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, gaming system, mobile computing device, or any other type and/or form of computing, telecommunications, or media device that is capable of communication and that has sufficient processor power and memory capacity to perform the operations described herein. In some embodiments, the computing device 100 may have different processors, operating systems, and input devices consistent with the device. In other embodiments, the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices manufactured by Apple Inc. of Cupertino, Calif. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J.; Motorola Inc. of Schaumburg, Ill.; or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the iPad line of devices, manufactured by Apple Inc.; the PlayBook manufactured by Research In Motion (doing business as “Blackberry”); the Cruz line of devices manufactured by Velocity Micro, Inc. of Richmond, Va.; the Folio and Thrive line of devices manufactured by Toshiba America Information Systems, Inc. of Irvine, Calif.; the Galaxy line of devices manufactured by Samsung; the HP Slate line of devices manufactured by Hewlett-Packard; and the Streak line of devices manufactured by Dell, Inc. of Round Rock, Tex.

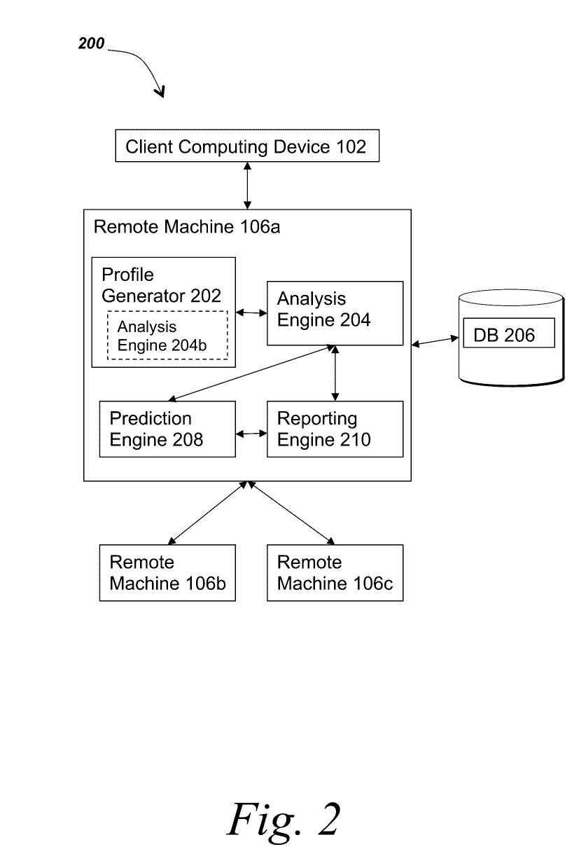

Referring now to FIG. 2, a block diagram depicts one embodiment of a system 200 for providing a performance improvement recommendation to a professional. In one embodiment, the system 200 includes functionality for generating a profile of the professional, for analyzing the profile, and for generating the performance improvement recommendation based on the analysis. In brief overview, the system 200 includes a client computing device 102 (which may also be referred to as a client device 102), remote machines 106a-c, a profile generator 202, an analysis engine 204, a prediction engine 208, and a reporting engine 210. In some embodiments, the system 200 includes a workflow engine (not shown). In some embodiments, the profile generator includes a second analysis engine 204b. In some embodiments, the system 200 generates the performance improvement recommendation for an institution, company, or other organization.

In one embodiment, a professional is a medical professional. For example, the professional may be any kind of doctor, a medical student, a nurse, a pharmacist, or a healthcare professional. In another embodiment, the professional is an individual working in a professional services environment such as, without limitations, a lawyer, a consultant, a real estate professional, or a financial services professional (e.g., accountants and bankers). In some embodiments, a professional provides support services to other professionals in an industry. For example, an industry professional may be a sales person selling pharmaceutical products to doctors or a jury consultant assisting litigators with jury selection. In other embodiments, professionals include students (of any discipline), education professionals (teachers, school administrators, etc.), athletes, and politicians.

In one embodiment, an entity is any company, non-profit, or other organization. In another embodiment, an entity includes a person other than a person profiled in their professional role (e.g., a “non-professional” person). In some embodiments, entities include machines and resources.

The profile generator 202 automatically generates a profile of at least one of a professional and an entity. In some embodiments, the profile includes at least one identification of a professional connection of the at least one of the professional and the entity. In other embodiments, the profile includes at least one lifestyle characteristic of a professional.

The analysis engine 204 analyzes the generated profile. In some embodiments, the analysis engine 204 determines, responsive to the analysis, a level of expertise of a professional in an industry. In some embodiments, a profiled individual or entity has a level of domain expertise. In some embodiments, a level of expertise refers to a level of familiarity with a particular subject. In other embodiments, the analysis engine 204 determines a level of influence. For example, the analysis engine 204 may determine that a profiled individual or entity has a level of influence over one or more other individuals or entities based, at least in part, on the level of expertise the profiled individual or entity has in a particular industry or domain. In one embodiment, a level of expertise refers to one or more internal factors—factors specific to, or internal to, a profiled professional—while a level of influence refers to one or more external factors—factors independent of the professional and relating to the professional's interactions with others. Examples of factors considered in establishing levels of expertise include numbers of articles, numbers of grants, levels of involvement in particular organizations, numbers of organizations with which the individual interacts (e.g., a number of interactions an academic has with a professional in industry or vice versa), a factor relating to a clinical practice, a volume of patients, clinical experience, and clinical interactions. Examples of factors considered in establishing levels of influence include external factors associated with a profiled professional, such as a reporting structure relative to another professional or a professional connection such as a mentoring, training or other connection between the profiled professional and a second professional. In other embodiments, a level of influence refers to a degree of reach of a professional or for how long the professional influences others' behaviors. In further embodiments, the analysis engine 204 determines both a level of expertise and a level of influence. The analysis engine 204 transmits, to a second computing device, an identification of the determined level of expertise.

Referring now to FIG. 2, and in greater detail, the profile generator 202 generates a profile of a professional or an entity. In one embodiment, the profile generator 202 accesses a database 206 to retrieve data associated with the professional or entity. In another embodiment, the profile generator 202 accesses a second computing device 106 to retrieve data associated with the professional or entity; for example, the profile generator 202 may query a remotely located database or computer. In still another embodiment, the profile generator 202 accesses a second computing device 106 to identify a professional or entity for whom to generate a profile.

In some embodiments, the profile generator 202 includes a second analysis engine 204b (depicted in shadow in FIG. 2). In one of these embodiments, the second analysis engine 204b analyzes data retrieved by the profile generator 202. In another of these embodiments, the second analysis engine 204 determines whether to include the analyzed data in the generated profile. In one example, the second analysis engine 204b may include the functionality of the analysis engine 204. In another example, the second analysis engine 204b is a version of the analysis engine 204 that has been customized to include functionality for determining whether to include data in a generated profile. In other embodiments, the profile generator 202 is in communication with a second analysis engine 204b. In further embodiments, the profile generator 202 accesses the analysis engine 204, which makes a determination as to whether to include data in a generated profile.

In some embodiments, the profile generator 202 stores a generated profile in a database 206. In some embodiments, the database 206 is an ODBC-compliant database. For example, the database 206 may be provided as an ORACLE database manufactured by Oracle Corporation of Redwood City, Calif. In other embodiments, the database 206 can be a Microsoft ACCESS database or a Microsoft SQL server database manufactured by Microsoft Corporation of Redmond, Wash. In still other embodiments, the database may be a custom-designed database based on an open source database, such as the MYSQL family of database products distributed by Oracle Corporation of Redwood City, Calif. In some embodiments, the database 206 is maintained by, or associated with, a third party.

The analysis engine 204 analyzes a generated profile, and determines, responsive to the analysis, a level of expertise of the professional in an industry. In one embodiment, the analysis engine 204 includes functionality for retrieving stored profiles from a database 206. In another embodiment, the analysis engine 204 includes functionality for requesting profiles and receiving profiles from the profile generator 202. In still another embodiment, the analysis engine 204 includes functionality for accessing previously analyzed profiles for comparison with a generated profile.

Referring still to FIG. 2, the system includes a prediction engine 208. In one embodiment, the prediction engine 208 receives data from the analysis engine 204. In another embodiment, the prediction engine 208 receives data from the profile generator 202. In still another embodiment, the prediction engine 208 retrieves information from a database 206. In yet another embodiment, the prediction engine 208 predicts future modifications to a professional's profile or level of expertise.

In one embodiment, the prediction engine 208 accesses data ontologies (including, in some instances, different ontologies for different verticals), algorithms and processes that organize, collect and disambiguate industry transaction payments, clinical experience, and clinical operations, from data sources (e.g., ‘Doctor X was paid $50 for food services’ vs. ‘Pfizer reimbursed Doctor Y $200 as part of a speaking engagement’; ‘Doctor X has seen 30 patients with diabetes’ vs. ‘Doctor Y has done four hip operations’). In another embodiment, the prediction engine 208 accesses frameworks that compare data sets against other available data sets (e.g., hospital web sites, state board information, publication history, electronic medical records, hospital claims, etc.) to help fill in gaps when information is only partially available. In still another embodiment, the prediction engine 208 executes algorithms that, because of the size of the data set, allow the use of one piece of data to assess the importance of another piece of data.

In some embodiments, the prediction engine 208 uses a normalized, cleaned data set to drive a predictive model of interactions. In one embodiment, the prediction engine 208 analyzes a data set to identify types of engagements valuable to a professional; for example, by a frequency comparison to a set of industry transactions that have occurred. In another embodiment, the prediction engine 208 identifies the patterns that typically lead up to such engagements in advance of such engagements actually occurring. In yet another embodiment, secondary variables and external data sets (e.g., macroeconomic conditions) are used to further improve accuracy and create finer and finer categories that describe professionals' behaviors. In some embodiments, the system includes an architecture in which components periodically monitor a plurality of data sources and analyze periodically updated data models that combine and merge secondary data with more direct data.

In one embodiment, the system includes a presentation layer that provides user-facing context to the analytics. In another embodiment, the presentation layer provides user-generated data back to the profile generator 202, creating an interactive feedback loop of user-generated data. In still another embodiment, information is exposed to the end user (e.g., any type of professional) who may, for example, annotate predictions for correctness, thus generating a new data stream that the prediction engine 208 uses to refine future predictions and/or that the profile generator 202 uses to refine future profile generation. In a further embodiment, the end user may access the presentation layer in order to generate queries; for example, the end user may make requests for identifications of professional profiles or requests for identifications of individuals who satisfy requirements for industry opportunities, via the presentation layer, which may be provided as a web site including at least one user interface with which the end user may submit queries.

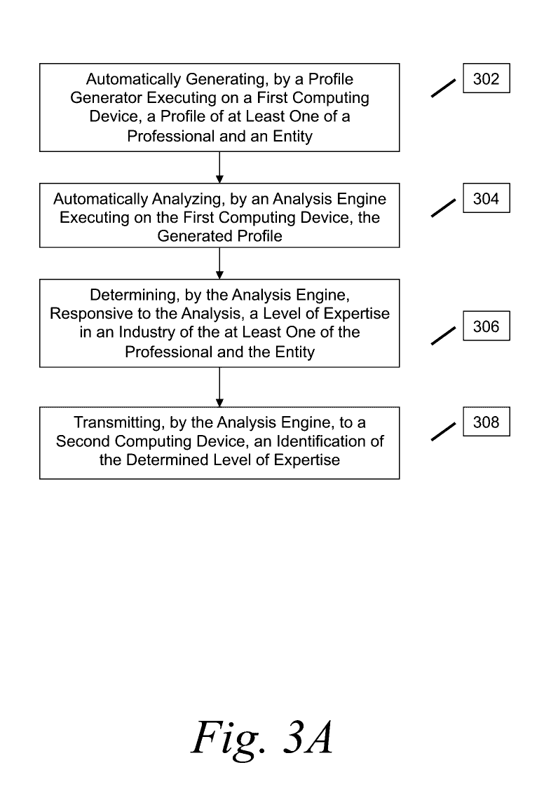

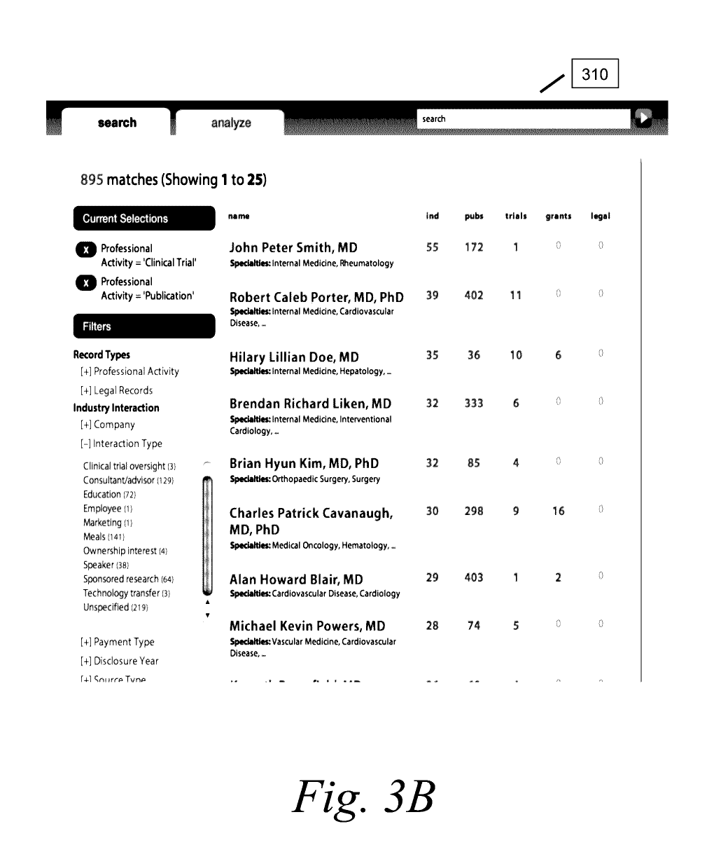

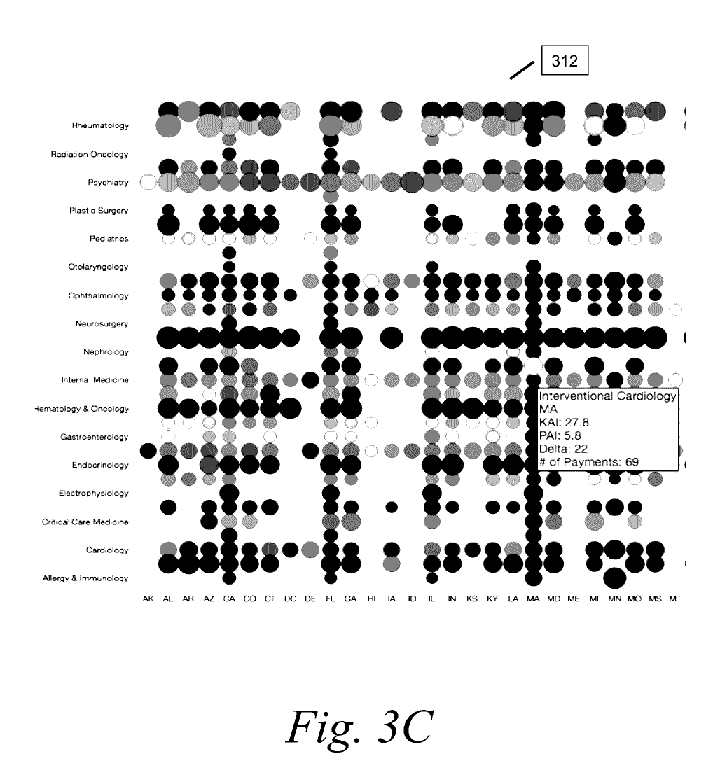

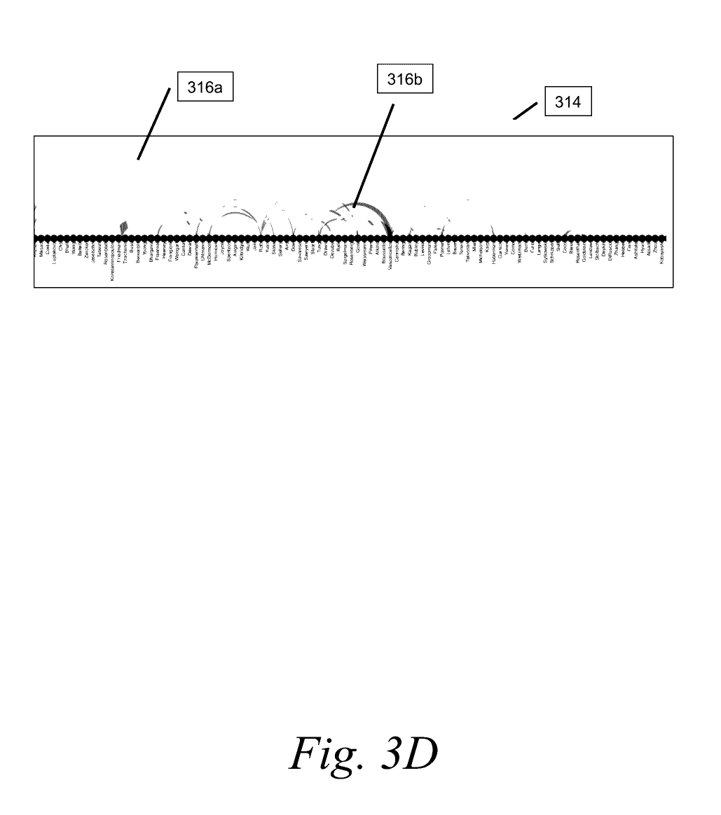

Referring now to FIG. 3A, a flow diagram depicts one embodiment of a method for profiling at least one of a professional and an entity. In brief overview, the method includes automatically generating, by a profile generator executing on a first computing device, a profile of at least one of a professional and an entity (302). The method includes automatically analyzing, by an analysis engine executing on the first computing device, the generated profile (304). The method includes determining, by the analysis engine, responsive to the analysis, a level of expertise in an industry of the at least one of the professional and the entity (306). The method includes transmitting, by the analysis engine, to a second computing device, an identification of the determined level of expertise (308).

Referring now to FIG. 3A, and in greater detail, the profile generator 202 automatically generates a profile of at least one of a professional and an entity (302). In one embodiment, the profile generator 202 generates an initial profile of either the professional or the entity automatically and without any input from the professional. In such an embodiment, the profile generator 202 generates the profile without the professional requesting the generation of the profile and without the professional or the entity providing any information to the system. In another embodiment, the profile generator 202 may receive input from the professional or the entity modifying the automatically generated profile; for example, the remote machine 106 may execute a web server displaying a web page from which the professional or an individual associated with the entity can make modifications to the profile after the profile generator 202 generates the profile.

Referring to FIG. 3B, a screen shot depicts one embodiment of profiles generated by the profile generator 202. In one embodiment, a user interface 310 displays a listing of profiled professionals. As shown in FIG. 3B, by way of example, a listing of a profiled professional may include a summary of the professional's specialties, a number of publications by the professional, a number of grants, and a number of trials participated in. As shown in FIG. 3B, the user interface 310 may provide functionality allowing users to search for profiled professionals. In other embodiments not shown in FIG. 3B, profiles include listings of other attributes (in addition to or instead of other attributes listed) such as number of clinical encounters, case types, and characterization of a physician's patient panel.

Referring back to FIG. 3A, and in one embodiment, the profile generator 202 accesses local and remote databases to automatically generate the profile. In another embodiment, the profile generator 202 identifies connections the professional or entity has to other professionals or entities—including, for example, co-workers, employers, employees, mentors, mentees, colleagues, co-authors, co-presenters, and vendors. For example, the profile generator 202 may search, without limitation, databases of publications (e.g., journal databases), hospital databases (e.g., to find out where a doctor works), databases of current and former academic faculty (e.g., to find out where someone taught or teaches, or which professors a professional studied under), social media databases, databases of sports club or gym memberships, and databases of alumni (e.g., to determine where the professional went to school). In still another embodiment, the profile generator 202 may search databases including, without limitation, databases storing information relating to demographics, professional writing (publications, etc.), disciplinary, legal, medical, economic, and credentialing information. In some embodiments, the profile generator 202 accesses primary data. In other embodiments, the profile generator 202 accesses secondary data. In still other embodiments, the profile generator 202 accesses some data directly and some data indirectly, for example, by inferring information or relationships from other data (i.e., inferring the existence of mentoring relationships). In further embodiments, the profile generator 202 accesses user-generated data. In some embodiments, the profile generator 202 accesses publicly available information. In other embodiments, the profile generator 202 accesses proprietary databases.

In some embodiments, the profile generator 202 accesses data including, without limitation, a level of education; an affiliation with an educational institution; a type of profession; an area of specialization within a profession; an identification of a professor; an identification of a mentor; an identification of an employer, publications, presentations, professional affiliations, memberships, types of clients, and of office buildings; an identification of a colleague; an identification of a geographical area within which the professional works or lives; biographical information, and areas of expertise; data not explicitly associated with a professional attribute of the professional may be referred to as a lifestyle characteristic. In some embodiments, the profile generator 202 accesses user-generated data. In other embodiments, the profile generator 202 accesses interaction data such as what drugs physicians prescribed, what procedures they followed, to whom they have referred patients or colleagues, preferences as to brand, and lifecycle data.

In some embodiments, the profile generator 202 analyzes accessed data to determine whether to include the accessed data in a profile. In other embodiments, the profile generator 202 determines whether accessed data is duplicative of data already in the profile. For example, the profile generator 202 may perform entity resolution (e.g., determining that “Doctor J. Reynolds” is the same individual as “Jonathan Reynolds, MD”). In one of these embodiments, the profile generator 202 determines whether accessed data indicates that data already in the profile is no longer current or has been modified over time. In further embodiments, the profile generator 202 may identify data to include in a profile using a chain of inference. For example, analyzing a professional's name associated with a publication in a well-regarded journal may allow the profile generator 202 to determine that the professional has a particular area of domain expertise; the area of domain expertise and the professional's name may allow the profile generator 202 to perform a search of a database providing additional data relating to the professional (e.g., a license number, membership, employer, or other data).

In some embodiments, the profile generator 202 is not dependent upon self-entry of data. In other embodiments, the profile generator 202 accesses passively collected data to generate a profile. In one of these embodiments, the profiled individual or entity is not aware of the data collection process. In another of these embodiments, the profile generator 202 accesses administrative or clinical systems to generate a profile. By way of example, and without limitation, administrative systems may include billing, operational, or human resources systems. As another example, and without limitation, clinical systems may include electronic medical record systems, case registries, or hospital billing systems.

In one embodiment, the profile generator 202 generates a profile for a professional; for example, and without limitation, the profile generator 202 may generate a profile of a physician. In another embodiment, the profile generator 202 generates a profile for a provider of a good or service; the profile generator 202 may generate a profile for a diverse set of providers including, by way of example and without limitation, a provider such as a medical device company, a pharmaceutical company, a professional services company, or individuals employed by such companies. In still another embodiment, the profile generator 202 generates an institutional profile. For example, as indicated above, the profile generator 202 may generate a profile for a company, which may include entities of varied corporate structures (for-profit, not-for-profit, non-profit, and charitable organizations generally). In yet another embodiment, the profile generator 202 generates a profile of an opportunity. For example, the profile generator 202 may generate a profile for an opportunity such as a job opportunity (e.g., a potential client looking to hire a professional, an opportunity in a particular industry such as a consulting or speaking opportunity, or an opportunity with an entity seeking to hire a professional on a contract-, full-, or part-time basis).

In one embodiment, the profile generator 202 uses the generated profile to generate a second profile. For example, in generating an entity's profile, the profile generator 202 may incorporate data from profiles associated with employees of the entity. As another example, in generating an individual's profile, the profile generator 202 may incorporate data from profiles associated with direct reports, mentees, mentors, or other profiled individuals. In some embodiments, therefore, the profile includes at least one identification of a professional connection of the profiled entity or individual. In other embodiments, the profile includes at least one identification of a lifestyle characteristic of a profiled individual (e.g., of memberships, hobbies, activities, travel preferences, or other characteristics that may not be related to the individual's profession).

In some embodiments, the profile generator 202 generates a profile for an entire organization; for example, in addition to profiling a professional, the system may generate profiles for companies, academic institutions, professional associations, or other entities. In one of these embodiments, the analysis engine 204 analyzes profiles for individuals within the organization to develop a profile for the organization as a whole. In another of these embodiments, the analysis engine 204 analyzes the organizational profile to generate a level of expertise of the organization. By way of example, a teaching hospital hiring highly qualified doctors and renowned for its work in a particular medical specialty may have a high level of expertise in that industry; such a level of expertise would be relevant to, for example, a medical student seeking to work in the medical specialty, a medical device company seeking to receive the perspective of reputable doctors on a new device, or a patient seeking a certain level of expertise from his or her doctor. In other embodiments, the profile generator 202 generates a profile for an organization independent of generating a profile for any individual professional affiliated with the organization (e.g., by generating a profile for a hospital without generating profiles for individual employees of the hospital).

The analysis engine, executing on the first computing device, automatically analyzes the generated profile (304). In one embodiment, the analysis engine 204 analyzes the generated profile to identify characteristics indicative of a level of expertise.

In some embodiments, the analysis engine 204 analyzes the generated profile to identify characteristics indicative of a level of influence, which, in one of these embodiments, includes a degree of reach of a physician, or for how many others the physician has a level of influence, or for how long the physician influences others' behaviors. In some embodiments, drivers of influence include publications, grants, patents, referral volume, number of years of experience, degrees of risk, degrees of compliance, and tenure at particular hospitals. In other embodiments, levels of expertise are factors internal to the profiled professional, such as, without limitation, publications, grants, and experience (including clinical experience); levels of influence may be factors external to the profiled professional, such as reporting structure or training structure.

In one embodiment, the analysis engine 204 analyzes a network of professionals to which the profiled professional belongs. The analysis engine 204 may identify ways in which the profiled professional stands out from peers in the network of professionals. The analysis engine 204 may identify characteristics that the profiled professional has in common with peers in the network of professionals. The analysis engine 204 may identify professionals in the network who are farther along in their careers than the profiled professional and compare and contrast the two. In some embodiments, the analysis engine 204 may analyze any or all of the data accessed by the profile generator 202 including, but not limited to, information listed above in connection with FIG. 2.

The analysis engine determines, responsive to the analysis, a level of expertise in an industry of the at least one of the professional and the entity (306). The analysis engine 204 may, for example, determine that a publication generated by the profiled professional is accessed by a majority of the members of his or her professional network or by influential members of the industry. In some embodiments, the level is provided as a descriptive term or phrase. In other embodiments, the level is provided as a binary value (e.g., “expert” or “not an expert”). In further embodiments, however, the level is not provided as a binary value but as a range based upon—and varying based upon—one or more weights. For example, the analysis engine 204 may be configured to weight certain types of profile data more or less heavily than others and to combine the various weights of various profile data to generate a level of expertise; in generating a profile of a researcher, for example and without limitation, the analysis engine 204 may count a recent publication in a prestigious journal as worth 0.7 points, while only weighing employment with a second tier institution as 0.2 and then combine the two to generate an overall level of expertise as 0.9 (e.g., out of 1.0).

The analysis engine transmits to a second computing device, an identification of the determined level of expertise (308). In one embodiment, the analysis engine 204 transmits the identification of the determined level of expertise to the professional. In another embodiment, the analysis engine 204 transmits the identification of the determined level of expertise to an employer of the professional. In still another embodiment, the analysis engine 204 transmits the identification of the determined level of expertise to a second professional; for example, the second professional may be a student seeking a mentor, a vendor seeking to sell a product in the industry and looking for an influential advocate within the industry, a job hunter seeking employment with an influential member of the industry, or other professional. In embodiments in which the analysis engine 204 determines a level of influence of the profiled professional, the analysis engine 204 may transmit the determined level of influence to the second computing device in addition to, or instead of, the level of expertise. In some embodiments, the analysis engine 204 provides the identification of the level of influence to the prediction engine 208 for use in generating predictions regarding future modifications to the level of influence. In other embodiments, the analysis engine 204 provides the identification of the level of influence to the profile generator 202 for inclusion in the profile of the professional. In further embodiments, the analysis engine 204 uses the level of influence in further analysis of the professional.

In some embodiments, the analysis engine 204 may make an identification of a profiled individual or entity available to another individual or entity. For example, the analysis engine 204 may make an identification of a profiled institution available to a professional who would benefit from an opportunity with the profiled institution (e.g., by sending a professional an identification of an industry opportunity to an academic or individual outside the industry with a profile of the entity offering the industry opportunity and an identification of a level of influence or expertise of the entity).

Referring now to FIG. 3C, a screen shot depicts one embodiment of a description of a level of expertise for each of a plurality of profiled professionals. As shown in FIG. 3C, the analysis engine 204 may generate an index 312 of levels of expertise for each of a plurality of professionals; the index may be referred to as an affinity index. The index 312, by way of example, may include listings of specialties or types of professionals and regions in which the professionals work, and include an interface with which users may compare levels of expertise of various professionals.

Referring now to FIG. 3D, a screen shot depicts one embodiment of a description of a level of expertise for each of a plurality of profiled professionals. As shown in FIG. 3D, the analysis engine 204 may generate a graphical depiction 314 of the varying levels of expertise of a number of profiled professionals. As an example, the graphical depiction 314 may include a line 316 connecting two professionals to indicate a connection and may use a characteristic of the line 316, such as a width of the line 316, to indicate a level of influence the professionals have on each other. By way of example, line 316a is a much thinner line than line 316b and, in one embodiment, this may indicate that the professionals connected by line 316a are not as influential on one another as the professionals connected by line 316b.

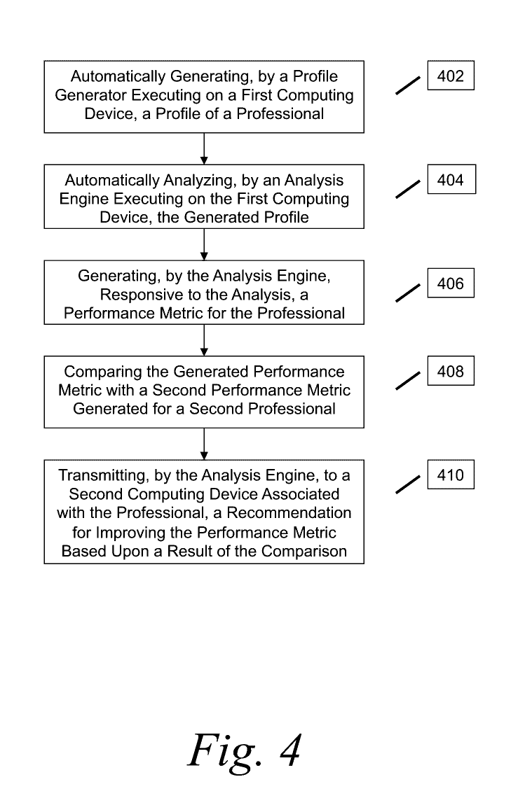

In some embodiments, the analysis engine 204 receives a profile of a second professional and compares the generated profile with the profile of the second professional. Referring again to FIG. 3A, and in connection with FIG. 2, in one embodiment, the prediction engine 208 executing on the first computing device generates a prediction of a future modification to the generated profile, responsive to the comparison. In another of these embodiments, the prediction engine 208 predicts a future level of expertise of the at least one of professional and the entity. For example, the analysis engine 204 may receive a profile of a mentor to a profiled professional and compare the mentor's profile with the generated profile. Based on the comparison, the prediction engine 208 may generate a prediction of a modification to the generated profile—for example, the analysis may indicate that every one of the mentor's previous mentees who attained a certain level of education went on to obtain jobs at a prestigious institution, as well as indicate that the profiled professional attained that level of education; the prediction engine 208 may evaluate the analysis and determine that the generated profile may eventually be modified to reflect employment at the prestigious institution. The prediction engine 208 may also generate a prediction of a future level of expertise by the profiled professional—for example, to reflect an increased level of expertise given the likelihood of attaining employment at the prestigious institution. In some embodiments, and as will be described in greater detail in connection with FIG. 4 below, the prediction engine 208 may generate a recommendation for an action the profiled professional can take to generate a profile that is more or less similar to the compared profile; alternatively, the analysis engine 204 may generate the recommendation.

In some embodiments, the prediction engine 208 accesses a neural network to generate the prediction. In other embodiments, the prediction engine 208 accesses one or more actuarial tables to generate the prediction. In further embodiments, systems and methods executing the prediction engine 208 provide access to a more efficient, superior quality prediction of expertise than a system based on manual entry of data or based on self-reported data due to the choice of data inputs used in creating a predictive model, a blend of algorithms used in creating the predictive model, and use of a feedback loop and/or machine learning to improve the quality of the predictive model.

Referring now to FIG. 4, a flow diagram depicts one embodiment of a method 400 for providing a performance improvement recommendation to a professional. The method 400 includes automatically generating, by a profile generator executing on a first computing device, a profile of a professional (402). The method includes automatically analyzing, by an analysis engine executing on the first computing device, the generated profile (404). The method 400 includes generating, by the analysis engine, responsive to the analysis, a performance metric for the professional (406). The method 400 includes comparing the generated performance metric with a second performance metric generated for a second professional (408). The method 400 includes transmitting, by the analysis engine, to a second computing device associated with the professional, a recommendation for improving the performance metric based upon a result of the comparison (410).

The profile generator executing on a first computing device automatically generates the profile of the professional (402). In one embodiment, the profile generator 202 automatically generates the profile as described above in connection with FIGS. 2-3D.

The analysis engine executing on the first computing device automatically analyzes the generated profile (404). In one embodiment, the analysis engine 204 analyzes the generated profile as described above in connection with FIGS. 2-3D. In another embodiment, the analysis engine 204 analyzes personal and professional data in order to identify strengths and weaknesses of the professional.

The analysis engine generates, responsive to the analysis, a performance metric for the professional (406). A performance metric may be a number. A performance metric may be a category. A performance metric may have any form that allows the performance metric of a first profiled professional to be compared to a second performance metric of a second profiled professional. In one embodiment, the analysis engine 204 bases the performance metric on a level of influence determined during the analysis. By way of example, the analysis engine 204 may incorporate the use of a statistic that reflects the importance of a term or concept across and within a collection of bodies of texts (e.g., the term frequency—inverse document frequency) as part of the process of determining the performance metric. In another embodiment, the analysis engine 204 bases the performance metric on a level of expertise determined during the analysis. In some embodiments, the performance metric is the level of expertise. In other embodiments, the performance metric is calculated based on a delta between the level of expertise and the peer average. In still other embodiments, the performance metric is calculated based on a level of personal potential identified by the analysis engine 204. For example, the performance metric may incorporate a prediction of a future level of expertise made by the prediction engine 208 as described above in connection with FIGS. 2-3A. As another example, the system 200 may provide functionality for generating a “fingerprint” or profile of professionals, identify a senior individual whose early career trajectories align closely with a particular professional for whom a performance metric is being calculated, and compare the senior individual with the professional to project a career path of the professional (e.g., determining that this professional is on the path to achieving a future career or level of influence or other metric of potential, similar to that of the senior individual). In other embodiments, the generation of performance metrics for one or more professionals allows for “fingerprinting” professionals along a common set of dimensions such as, without limitation, specialty, quality, experience, and risk; this allows for the derivation of archetypes or common personas amongst professionals. The application of such archetyping to a particular professional provides the professional with greater insight as to who his or her industry peers are and how the professional compares to those peers. In one embodiment, fingerprinting provides a characteristic of a provider's profile along various metrics.

In one embodiment the analysis engine 204 selects a subset of a plurality of features to characterize the professional. The features may include, without limitation:
Case mix/density: number/types of cases seen;
Case complexity: cases seen or worked on per day;
Performance variation: does performance vary by day of the week or the number of other (complex) cases seen that day;
Practice setting: for example, in an embodiment in which the professional is a physician, the system may analyze the professional's patient panel (is the professional practicing, for example, in a community hospital, in an urban setting, or in an Academic Medical Center);
Types of procedures performed (e.g., invasive, minimally invasive, cutting edge, etc.);
Types of procedures performed on, for, or on behalf of a client (e.g., Relative Value Units per patient);
Number of years in service;
Other professionals that the professional typically works with (an orthopod that works on his own vs. one that works as part of a broader team; a patent attorney that works on her own vs. one that works with corporate attorneys, trademark attorneys, and venture capitalists);
Fraction of time spent in various professional settings (e.g., a hospital vs. private clinic, or a home office vs. a corporate office);
Time spent per procedure, per client type (new client, patient checkup, initial consultation, etc.);
Client outcomes: for example, for a physician, outcomes may include readmission rates, patient satisfaction survey results, and unnecessary complications;
“Meaningful Use” Metrics and other metrics identified in programs administered by the Centers for Medicare and Medicaid Services (e.g., pay for performance programs);
Number of procedures performed: for example, for a physician, this may include a number of tests run, follow-up tests run;
Information density recorded (e.g., in an electronic medical record)—how many notes, how generic are they;
Referral patterns—how many clients does this professional receive from neighboring professionals
Average wait time—how long do clients have to wait to see this professional;
Research/clinical breakdown—details about the professional's research portfolio, if applicable—clinical trials, research papers, amicus briefs, white papers, etc.;
Client communication—e.g., used to determine how often clients call in, talk to the professional, or email the professional, as a sign of effective communication practices.
   In some embodiments, these types of factors are used not only to characterize the professional, but also to identify other professionals against which to compare the professional. In other embodiments, benchmarks may also be taken against this list. In one of these embodiments, benchmarks are additionally broken down by specialty and region and focused on other doctors in the same hospital. In one embodiment, the analysis engine 204 conducts a longitudinal analysis of the performance metric compared with a benchmark (for example, without limitation, a global benchmark).

The method 400 includes comparing the generated performance metric with a second performance metric generated for a second professional (408). In one embodiment, the analysis engine 204 performs the comparison. In some embodiments, the analysis engine 204 compares a level of expertise of the profiled professional with the level of expertise of the second professional.

In one embodiment, the analysis engine 204 selects the second professional based on a common characteristic between the two profiled professionals. In another embodiment, the profiled professional identifies a profile of a second professional that the profiled professional aspires to emulate. For example, the profiled professional may identify a key opinion leader, an individual with high levels of expertise in particular specialties, or other role model or competitor that the profiled professional wishes to emulate; the system 200 may use such an identification in selecting profiles against which to compare the profiled professional.

In one embodiment, the analysis engine 204 generates a recommendation for improving the performance metric based upon a result of the comparison. In some embodiments, the prediction engine 208 analyzes the profile to identify actions the professional can take to improve a level of influence or expertise. In other embodiments, the analysis engine 204 analyzes the profile to identify actions the professional can take to improve a level of influence or expertise and the prediction engine 208 predicts the impact the improvement will have on the level of influence or expertise. For example, the analysis engine 204 may determine that the professional may improve her level of influence or expertise in a community by taking on additional speaking engagements while the prediction engine 208 may quantify how much of an improvement a particular speaking engagement will have on the level of influence or expertise.

In one embodiment, the analysis engine 204 generates an identification of actions the profiled professional could take to improve weaknesses in the profile and to improve the overall performance metric. In the event that the profiled professional takes the identified action or otherwise implements the performance improvement recommendations, the profile generator 202 updates the profile to reflect the action taken and the analysis engine 204 can re-evaluate the profile to generate an updated performance metric and additional recommendations; in such an embodiment, the system may be referred to as supporting a “quantified self” since the professional's actions are thoroughly quantified and there is a closed loop in which actions lead to improved metrics and additional feedback for further improving various metrics. In some embodiments, the methods and systems described herein allow professionals to curate, highlight, amend, or emphasize various aspects of their profiles and to use the methods and systems to improve various performance metrics and steer future work, which can then be correlated to outcome and provide feedback into the various performance metrics in a continuous feedback loop.

The method includes transmitting, by the analysis engine, to a second computing device associated with the professional, a recommendation for improving the performance metric based upon a result of the comparison (410). In one embodiment, the analysis engine 204 also transmits an identification of a characteristic in the profile that impacted the performance metric.

In one embodiment, the analysis engine 204 transmits the performance improvement recommendation to the professional. In another embodiment, the analysis engine 204 transmits the performance improvement recommendation to an employer of the professional. In still another embodiment, the analysis engine 204 transmits the performance improvement recommendation to a second professional; for example, the second professional may be an industry professional looking to incentivize the profiled professional to work with the industry professional in exchange for gaining performance improving experience.

In some embodiments, the system 200 determines a level of compliance of a profiled professional with a disclosure requirement. In one of these embodiments, by way of example, the system 200 executes a method as described in U.S. patent application Ser. No. 13/653,675, entitled “Methods and Systems for Profiling Professionals,” incorporated herein by reference, to determine the level of compliance of a profiled professional or entity. In another of these embodiments, the system 200 identifies a performance improvement recommendation to provide to the profiled professional based upon the determined level of compliance. For example, the system 200 may determine that the profiled professional could improve his performance metric by increasing the determined level of compliance. As an example, the analysis engine 204 may determine that the profiled professional's performance metric is lower than a second professional's performance metric because the profiled professional has a lower level of compliance with particular disclosure requirements.

In some embodiments, the system 200 generates a customized disclosure report for a profiled professional. In one of these embodiments, by way of example, the system 200 executes a method as described in U.S. patent application Ser. No. 13/653,675, entitled “Methods and Systems for Profiling Professionals,” to generate the customized disclosure report. In another of these embodiments, the system 200 includes in the customized disclosure report an identification of a performance improvement recommendation provided to the profiled professional. For example, a regulatory agency may request an identification of performance improvement recommendations provided to the profiled professional. Such a regulatory agency may also request an identification of actions taken by the profiled professional to implement the performance improvement recommendations. The system 200 may satisfy the requirements of such a regulatory agency when generating the customized disclosure report.

In some embodiments, the system 200 identifies a future match between a professional and an industry opportunity. In one of these embodiments, by way of example, the system 200 executes a method as described in U.S. patent application Ser. No. 13/653,675, entitled “Methods and Systems for Profiling Professionals,” to identify the match between the professional and the industry opportunity. In another of these embodiments, when making the identification of the future match, the system 200 analyzes a behavior pattern of the profiled professional with respect to a type of performance improvement recommendation. For example, the system 200 may determine that when the profiled professional receives performance improvement recommendations, the profiled professional acts upon the recommendations; such behavior may impact the profiled professional's qualification for a particular industry opportunity either because the behavior directly impacts a performance metric or other requirement specified by the industry opportunity or because responsiveness to that type of recommendation is itself a requirement for the industry opportunity.

In some embodiments, the system 200 identifies a fair market value for compensating a profiled professional. In one of these embodiments, by way of example, the system 200 executes a method as described in U.S. patent application Ser. No. 13/653,675, entitled “Methods and Systems for Profiling Professionals,” to identify the fair market value. In another of these embodiments, when identifying performance improvement recommendations for the profiled professional, the system 200 may identify an impact of the performance improvement recommendation on the fair market value for compensating the profiled professional. For example, the system 200 may identify an amount by which the fair market value will increase if the profiled professional implements the performance improvement recommendation. As another example, the system 200 may identify an amount by which the fair market value will decrease if the profiled professional ignores the performance improvement recommendation.

In some embodiments, once the system 200 has compiled detailed information about the performance of a professional, the system 200 may be leveraged in developing a ‘co-management’ relationship between the professional and an employer. For example, a hospital employing a doctor may leverage the system in order to develop its relationship with the doctor. As another example, hospital systems often need to come up with creative ways to incentivize their physicians (e.g., see more patients and give them appropriate care) once the hospital systems begin to move away from a fee-for-service model. In one of these embodiments, the hospital may use information provided by the system 200 regarding the performance information of a physician to determine what an optimal compensation plan would be, and then track the physician's progress toward those goals; this may be, for example, the analogue of a sales agent's ‘commission plan,’ but broadly includes patient outcomes and system level decisions (leakage rates) as well.

In some embodiments, the system 200 identifies a characteristic of an industry opportunity that incentivizes a profiled professional to accept the industry opportunity. In one of these embodiments, by way of example, the system 200 executes a method as described in U.S. patent application Ser. No. 13/653,675, entitled “Methods and Systems for Profiling Professionals,” to identify the characteristic. In another of these embodiments, when identifying the characteristic, the system 200 may determine that the industry opportunity enabled the profiled professional to implement a performance improvement recommendation. For example, the performance improvement recommendation may have indicated that the profiled professional should complete additional speaking engagements, continuing education courses, or teaching opportunities, and the industry opportunity enabled the profiled professional to do so.

Although some of the examples provided herein describe the analysis in connection with the medical profession, the legal profession, and other professional service industries, one of ordinary skill in the art will understand that the methods and systems described herein are equally applicable in other industries. Similarly, although the description above categorizes professionals as industry professionals (such as providers of goods or services), professionals such as physicians, and employers of professionals, it should be understood that any one individual may be categorized as any one or more of these types of professionals; for example, an industry professional need not be a vendor but could be a physician seeking to provide an opportunity to another physician and an employer in a particular instance may be better categorized as an industry professional. As discussed in an example given above, a hiring manager in a business (e.g., an employer) may evaluate the behavior of a career development officer at an academic institution (e.g., an industry professional) to determine whether the career development officer is influential with graduating students (e.g., professionals) whom the business wishes to hire.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus, or article of manufacture using programming and/or engineering techniques to produce software, firmware, hardware, or any combination thereof The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices; firmware; programmable logic; hardware (e.g., integrated circuit chip, electronic devices, a computer-readable non-volatile storage unit, non-volatile memory, such as semiconductor memory devices, including EPROM, EEPROM, and flash memory devices); magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for providing performance improvement recommendations to professionals, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for providing performance improvement recommendations to a professional, the method comprising:
automatically generating, by a profile generator executing on a first computing device, a profile of a professional;
automatically analyzing, by an analysis engine executing on the first computing device, the generated profile;
generating, by the analysis engine, responsive to the analysis, a performance metric for the professional;
comparing the generated performance metric with a second performance metric generated for a second professional; and
transmitting, by the analysis engine, to a second computing device associated with the professional, a recommendation for improving the performance metric based upon a result of the comparison.

2. The method of claim 1, wherein comparing further comprises conducting a longitudinal analysis of the performance metric compared with a benchmark.

3. The method of claim 1, wherein transmitting further comprises transmitting an identification of a characteristic in the profile, the characteristic impacting the performance metric.
